(19) United States
(12) Patent Application Publication
(10) Pub. No.: US 2015/0080514 A1
(43) Pub. Date: Mar. 19, 2015

(54) PROTECTIVE OVERCOAT FOR PRINTED IMAGES

(71) Applicant: XEROX CORPORATION, Norwalk, CT (US)

(72) Inventors: Guiqin Song, Milton (CA); Gordon Sisler, St. Catharines (CA); Michelle Chrétien, Mississauga (CA); Nan-Xing Hu, Oakville (CA)

(73) Assignee: XEROX CORPORATION, Norwalk, CT (US)

(21) Appl. No.: 14/028,875

(22) Filed: Sep. 17, 2013

(51) Int. Cl. C09D 123/08; C09D 131/04; C09D 133/00

(52) U.S. Cl. CPC C09D 123/0853; C09D 133/00; C09D 131/04; C08K 3/22
USPC 524/430; 524/524; 524/563; 524/506

(57) ABSTRACT

A method includes forming a film over a printed image on a substrate, the film includes a print overcoat composition having a binder that includes an aqueous vinylacetate-ethylene copolymer emulsion, (1) a particulate additive as a dispersion or emulsion, (2) a co-binder, or (3) both, and a surfactant, the film provides wear and scratch resistance to the printed image.

### BACKGROUND

Embodiments disclosed herein relate to overcoat compositions employed to protect printed images. More particularly, embodiments disclosed herein relate to overcoat compositions and methods of their use to protect printed images from scratch and wear.

Known methods of protecting ink or toner-based images include applying an overcoat composition to a substrate bearing the image. The coating of print images made with solid ink or wax-based ink, however, can be especially challenging due to a reduced robustness against scratch and abrasion of such prints relative to other inkjet or xerographic prints. It would be beneficial to develop an overcoat that provides these susceptible printed images with scratch and smear (or rub) resistance.

### BRIEF DESCRIPTION OF THE FIGURES

FIG. 1A shows a bar graph plot of 75 degree gloss on a white copy paper.

FIG. 1B shows a bar graph plot of 75 degree gloss on a color gloss copy paper.

### SUMMARY

In some aspects, embodiments disclosed herein relate to methods comprising forming a film over a printed image on a substrate, the film comprising a print overcoat composition comprising a binder comprising an aqueous vinylacetate-ethylene copolymer emulsion, (1) a particulate additive as a dispersion or emulsion, (2) a co-binder, or (3) both, and a surfactant, wherein the film provides wear and scratch resistance to the printed image.

In some aspects, embodiments disclosed herein relate to print overcoat compositions comprising a binder comprising aqueous vinylacetate-ethylene copolymer emulsion, a particulate additive comprising an aqueous dispersion of alumina oxide nanoparticles, an optional micronized wax emulsion, and a surfactant.

In some aspects, embodiments disclosed herein relate to print overcoat compositions comprising a binder comprising an aqueous vinylacetate-ethylene copolymer, a co-binder comprising an aqueous polymer latex, wherein the polymer of the latex has a glass transition temperature in a range from −42° C. to about 85° C., and a surfactant.

### DETAILED DESCRIPTION

Embodiments disclosed herein provide overcoat methods and compositions for protecting printed images, especially printed images generated from solid inkjet printing. Overcoat compositions disclosed herein may impart good scratch resistance, excellent folding and abrasion damage resistance and higher gloss. In embodiments, overcoat compositions disclosed herein comprise primary binders based on vinyl acetate ethylene (VAE) emulsions with various additional particulate additives, optional co-binders, plus other optional additives such as defoamers and leveling agents. Particulate additives may include nanoparticulate aluminum oxide, silicone powders, emulsion waxes, such as micronized wax dispersions, and colloidal silica, among others. Particulate additives may be selected to enhance protection of the print image against physical damage. Co-binders may include acrylic latexes with different T_{g}.

Aqueous vinyl acetate-ethylene copolymer binder possesses very good dry pick and wet pick strengths and has been widely used in pigmented paper coating application to provide printing adaptability as gloss, whiteness, light resistance and proper stiffness. In such paper coating applications, VAE is integrated into the paper itself at the paper manufacture stage and print images are subsequently disposed on the surface of the paper. By contrast, embodiments disclosed herein provide VAE as a base material in an overcoat composition which is placed over a printed image. VAE, optionally in conjunction with other co-binders, such as low T_{g} acrylic latexes, and/or other particulate additives, provides overcoat compositions having substantially tunable gloss characteristics compared to the uncoated prints. As used herein “particulate additive” is a used to describe additives that may be provided as dispersions or emulsions or powder that provide varied functionality. In embodiments, aluminum oxide nanoparticles are particulate additives, which may provide, inter alia, scratch and wear resistance. Other particulate additives include, without limitation, micronized wax emulsions, silicone powders, colloidal silica, and the like.

The scratch, wear and fold properties of the overcoating compositions disclosed herein are particularly enhanced by the presence of particulate additives such as aluminum oxide or emulsion waxes. Other additives, not necessarily particulate in nature, may be present such as surfactants or leveling agents to achieve uniform wetting and lay down. Methods disclosed herein are particularly suitable for print applications on porous media where solid inks perform well to prevent bleeding, but are otherwise vulnerable to scratching and smearing or may be transferred to other prints or may contaminate operating equipment. The overcoat compositions disclosed herein may overcome these problems associated with such solid inks. Methods of coating over entire prints, as disclosed herein, will not only form a protective film barrier and aid in increasing the robustness of the print but also increase the aesthetic value by increasing print gloss. These and other advantages will be apparent to those skilled in the art.

In embodiments, there are provided methods comprising forming a film over a printed image on a substrate, the film comprising a print overcoat composition comprising a binder comprising an aqueous vinylacetate-ethylene (VAE) copolymer emulsion, a particulate additive as a dispersion or emulsion, a co-binder, or both, and a surfactant, wherein the film provides scratch resistance to the printed image. In embodiments, the co-binder may be low T_{g} acrylic latexes. The particulate additves may include micronized wax dispersions/emulsions, colloidal silica or nano aluminum oxide dispersions, or combinations thereof.

In embodiments, the printed image comprises a solid or gel ink. Solid or gel inks are those known in the art that are generally solid at ambient temperatures, such as lower than 50° C., and which are applied to a substrate at elevated temperatures in a molten form by, for example, ink jet application. In embodiments, the printed image comprises a liquid or solvent-based ink. In embodiments, the printed image comprises a toner-based image.

In embodiments, the substrate may be porous. In other embodiments, the substrate may be non-porous. In embodiments, the substrate comprises a coated or uncoated paper. In embodiments, the paper may be porous. In some such embodiments, the ink employed may be a solid or gel ink. In embodiments, paper substrates may comprise optical brighteners and other additives to enhance image quality. The substrate employed in methods disclosed herein can be any appropriate substrate depending upon the end use of the print. Exemplary substrates include, but are not limited to, plain paper, coated paper, synthetic paper, polymeric films, xerographic printed substrates, and mixtures thereof.

The overcoat compositions employed in methods disclosed herein may be clear or substantially colorless. As used herein, “substantially colorless” refers to the overcoat composition being substantially or completely transparent or clear upon viewing. For this, the composition may be substantially free of colorants.

The overcoat compositions disclosed herein may be overcoated onto the prints by using coating methods such as roll-to-roll coating, which includes air knife coating, anilox or flexo coating, curtain coating, flexo coating, gravure coating and metering rod (Meyer bar) coating. In embodiments coating methods may include spray coating. The apparatus employed in coating can be configured for use inline with printing processes or may be offline, i.e., separate from the printing process.

The overcoat compositions disclosed herein can be used in image processing comprising generating an ink-based or toner-based image on a substrate, following the generation of the image, the overcoat is disposed onto the substrate as a whole, onto the image as a whole, onto part(s) of the image, onto part(s) of the substrate, or any combination thereof, followed by drying the overcoat composition.

When coating a toner-based image, the fused toner-based print may be obtained first followed by placement of the overcoat composition. The toner-based print can be prepared by any suitable conventional xerographic technique or variant thereof. Similarly, when coating an ink-based image, the ink-based image is generated first and then the overcoat composition is placed over the image. Ink-based images can be formed using an ink jet printer, and the overcoat composition is coated onto the substrate and/or image as a colorless, transparent fluid after the ink jet ink image is formed. When the overcoat composition is coated over an ink-based image, particularly, an image produced using an ink jet printer, the image can be prepared by any suitable conventional process or variant thereof.

Methods disclosed herein further comprise drying the film on the substrate. In embodiments, drying the film may be performed at elevated temperatures with proper air flow, such as about 50-60° C.

In embodiments, the dried film may exhibit a 75 degree gloss of at least 60 gloss units (GU) on 92 bright, 20 pound bond paper. Gloss is associated with the capacity of a surface to reflect more light in directions close to the specular than in others. In embodiments, gloss may be measured with a 75 degree gloss meter such as the Micro-Gloss 75 (Qualitest, Fort Lauderdale, Fla.). The standard set forth in TAPPI T480 OM-05 may be used for this purpose. In embodiments, gloss may be measured by other standards, such as by ASTM D523-08 Standard Test Method for Specular Gloss. Measurements by this test method correlate with visual observations of surface shininess made at roughly the corresponding angles. Measured gloss ratings by this test method are obtained by comparing the specular reflectance from the specimen to that from a black glass standard. Since specular reflectance depends also on the surface refractive index of the specimen, the measured gloss ratings change as the surface refractive index changes.

As used herein, “print overcoat” refers to a film-forming composition that is disposed over a printed image to confer scratch and smear resistance to the image. Print overcoats may be applied by printing techniques or any other coating technique known in the art. In general, a print overcoat may be transparent and colorless. In embodiments, a print overcoat may have a gloss or matte finish. Print overcoats disclosed herein comprise a primary binder resin based on vinyl acetate-ethylene (VAE) emulsions.

In embodiments, there are provided print overcoat compositions comprising a binder comprising an aqueous vinyl acetate-ethylene copolymer emulsion. In embodiments, composition may comprise a binder together with one or two or three co-binders, such as an aqueous vinyl acetate ethylene copolymer emulsion and acrylic latexes as co-binders, a particulate additive comprising an aqueous dispersion of alumina oxide nanoparticles, and a surfactant. Other particulate additives described herein may be employed in addition to or in lieu of alumina oxide nanoparticles.

As used herein, “binder” refers to the main polymer vehicle for film formation in print overcoat compositions. In embodiments, VAE may be the primary binder employed in overcoat compositions. In other embodiments, VAE may be used in conjunction with a secondary binder resin, such as a low T_{g} acrylic latex.

Vinyl acetate-ethylene (VAE) emulsions employed in overcoat compositions disclosed herein are aqueous-based emulsions of a copolymer in which the vinyl acetate monomer content is in a range from about 60 percent to about 95 percent by weight of the copolymer. Thus, VAE is distinct from what is known in the art as ethylene-vinyl acetate (EVA) copolymer which comprises from about 10 to about 40 percent vinyl acetate by weight of the copolymer. By way of example, where VAE is typically provided as a water-based emulsion, whereas EVA is frequently provided as a solid material for hot melt and plastic molding applications. VAE emulsions provide a good balance between adhesive characteristics and coating strength. Moreover, because VAE emulsions are aqueous-based, they provide an environmentally friendly alternative coating binder.

In embodiments, the T_{g} of the VAE emulsion may be varied according to specific ethylene content. As ethylene content increases, the T_{g} generally decreases. The T_{g} of the VAE emulsion varies from about −15° C. to about 15° C. The VAE emulsion may be synthesized by known methods or can be obtained from any commericial source such as BRITECOAT™ 2730 (manufactured by Celanese Corporation and DA-100L (manufactured by DAIREN CHEMICAL CORPORATION).

In embodiments, the aqueous vinylacetate-ethylene copolymer emulsion is present in an amount from about 20 percent to about 90% by weight of the overcoat composition and is the main film forming polymer component. In other embodiments, the vinylacetate-ethylene copolymer is present in the emulsion in an amount from about 40 percent to about 60 percent by weight of the emulsion. In some such embodiments, a particulate filler may comprise a secondary binder material, such as a low T_{g} acrylic latex. The T_{g} may vary from about −42° C. to 85° C.

In embodiments, there are provided print overcoat compositions comprising binders, at least one of the binders comprising an aqueous vinylacetate-ethylene copolymer emulsion, wherein the aqueous vinylacetate-ethylene copolymer emulsion has a glass transition temperature in a range from about −25° C. to about 25° C., and one to five surfactants, particulate additives including nanoparticulate aluminum oxide, colloidal silica, emulsion waxes and some silicone additives to improve the wear and scratch properties. In some such embodiments, the aqueous vinylacetate-ethylene copolymer emulsion is present in an amount from about 10 percent to about 95 percent by weight of the composition. In embodiments, the co-binders are acrylic copolymer latexes. In embodiments, the aqueous acrylic latex has a glass transition temperature in a range from about −42° C. to about 85° C. In embodiments, the acrylic latex may be present or not, and when present may be in a non-zero amount up to about 95 percent by weight of the composition. In embodiments, such overprint compositions may further comprise a leveling agent.

In embodiments, methods disclosed herein may employ alumina nanoparticles as a particulate additive in the overcoat composition. In other embodiments, the particulate additive of the overcoat composition is selected from the group consisting of, a silicone powder, a colloidal silica, nano aluminum oxide and a slip control silicone additive, a micronized wax, and combinations thereof. Slip control silicone additives may include, without limitation, BYK 307, BYK 333, and BYK 378. The particulate additive may be selected to provide a more robust overcoat in order to confer scratch and wear resistance to the printed image. In embodiments, the particulate additive comprises alumina oxide nanoparticles having a particle size in a range from about 20 nm to about 250 nm, or about 30 nm to about 150 nm. In some such embodiments, the nanoparticulate size may be useful for dried overcoats that form a film from about 1 micron to about 20 microns, or about 2 microns to about 10 microns. In embodiments, the aluminum oxide nanoparticles may be outside these ranges, especially where a thicker overcoat may be desired. Thus, it may be beneficial to employ nanoparticulate aluminum oxide in a range from about 50 nm to about 150 nm for a final overcoat thickness of about 1 micron to about 10 microns, or about 150 nm to about 250 nm for a final overcoat thickness of about 10 to about 20 microns. In embodiments, the nanoparticulate aluminum oxide filler may be present in an amount from about 0.1 percent to about 10 percent by weight of the composition.

The overcoat compositions disclosed herein may further include conventional additives to take advantage of the known functionality associated with such conventional additives. Such additives may include, for example, defoamers, slip and leveling agents, stabilizers, UV absorbing additives, wear and scratch resistance additives and the like.

In embodiments, the overcoat compositions disclosed herein may comprise a surfactant. In particular embodiments, the surfactant may be a fluorosurfactant or silicone surfactant. In embodiments, the overcoat compositions disclosed herein comprises a surfactant that functions as a leveling agent. Exemplary surfactants and leveling agents are shown in Table 1 below. In some cases, the surfactants can be combined or blended to be used in the coating system.

TABLE 1

| Product | Supplier |
|---|---|
| CAPSTONE ™ FS-61 | DuPont |
| | Fluorosurfactants |
| CAPSTONE ™ FS-63 | DuPont |
| | Fluorosurfactants |
| CAPSTONE ™ FS-64 | DuPont |
| | Fluorosurfactants |
| CAPSTONE ™ FS-65 | DuPont |
| | Fluorosurfactants |
| CAPSTONE ™ FS-66 | DuPont |
| CAPSTONE ™ FS-81 | Fluorosurfactants |
| BYK ®-345 | BYK Chemie |
| BYK ®-346 | |
| BYK ®-347 | |
| BYK ®-348 | |
| BYK ®-349 | |
| BYK-3455 | |
| DYNW ET 800 | |
| Chemguard S-111 | Chemguard |
| Chemguard S-103A | Chemguard |
| Chemguard S-760p | Chemguard |
| Chemguard S-761p | Chemguard |
| Chemguard S-764p | |
| Chemguard S-500 | Chemguard |
| Chemguard S-550 | |
| Chemguard S-554 | |
| Chemguard S-559 | |
| Surfynol 420 | Air Products |
| Surfynol 440 | |
| Surfynol 465 | |
| Surfynol 104 Series | |
| EnviroGem360 | |
| Dynol ™ 604 | |
| Dynol ™ 810 | |
| Tergitol NP-9 | Dow Chemical |
| Tergitol 15-s-7 | |
| Tergitol 15-s-9 | |
| Tergitol 15-s-12 | |
| Tergitol TMN-6 | |
| Tergitol TMN-10 | |
| PolyFoxTMPF-136A | OMNOVA Solutions |
| PolyFoxTMPF-156A | |
| PolyFoxTMPF-151N | |
| TEGO ®Wet 260 | Evonik Industries |
| TEGO ®Wet 270 | |
| TEGO ®Wet 500 | |
| TEGO ®Twin 4100 | |
| ZONYL ® FSJ | DuPont |
| Dynax 4005N | Dynax Corporation |
| Dynax DX4000 | Dynax Corporation |
| Dynax DX4010N | Dynax Corporation |
| BAYOWET ® FT 248 | OMG Borchers |
| | GmbH |
| PERMUTEX ® LA-22- | Stahl |
| 605 | |
| THETAWET ™ FS 8000 | Innovative |
| THETAWET ™ FS 8050 | Technologies, Inc. |
| THETAWET ™ FS | |
| 8020DB | |
| THETAWET ™ FS | |
| 8020EB | |
| THETAWET ™ FS 8100 | |
| THETAWET ™ FS 8150 | |
| THETAWET ™ FS 8200 | |
| THETAWET ™ FS 8250 | |
| OT-75 | Cytec Industries, Inc. |
| OT-70PG | |
| OT-75PG | |

In embodiments, the surfactant is present in an amount from about 0.01 percent to about 5 percent by weight of the composition.

In embodiments, the overcoat further comprises a micronized wax powder or micronized wax emulsion. Examples are shown in Table 2 below.

TABLE 2

| | |
|---|---|
| MICHEM Emulsion 48040M1 | Michelman |
| MICHEM Emulsion 98040M1 | Michelman |
| MICHEM LUBE 743 | Michelman |
| IGI Wax | IGI |
| Johnwax 4 | BASF |
| Johnwax 22 | BASF |
| Johnwax 28 | BASF |
| AGROCER01 | Evonik Degussa |
| AGROCER02 | GmbH |
| AGROCER09 | Evonik Degussa |
| AQUACER498 | GmbH |
| AQUACER501 | Evonik Degussa |
| AQUACER513 | GmbH |
| AQUACER531 | BYK |
| AQUACER535 | BYK |
| AQUACER552 | BYK |
| Aquaslip 952 | BYK |
| MICROSPERSION 930 | BYK |
| | BYK |
| | Lubrizol |
| | MICRO POWDERS |

Waxes may include, without limitation micronized modified polyethylene wax, paraffins, microcrystalline waxes, polyolefin waxes such as polyethylene or polypropylene waxes, ester waxes, carnauba wax, fatty acids and other waxy materials and synthetic waxes. The wax may be present in an amount of from about 0.1% to about 15 by weight of the total solids. Examples of suitable waxes include polypropylenes and polyethylenes commercially available from Allied Chemical and Petrolite Corporation, wax emulsions available from Michaelman Inc. and the Daniels Products Company, EPOLENE N-15 commercially available from Eastman Chemical Products, Inc., MICROSPERSION 930 from MICRO POWDERS, INC. Non-ionic emulsion based on a modified polyethylene wax such as AQUACER 513, AQUACER 515, AQUACER 552, AQUACER 531 and Micronized modified polyethylene wax CERAFLOUR 925 and CERAFLOUR 929 from BYK (and similar materials available from SC Johnson Wax), chlorinated polypropylenes and polyethylenes commercially available from Allied Chemical and Petrolite Corporation and SC Johnson wax.

In embodiments, clear overcoat compositions disclosed herein may comprise an optional UV absorbing additive. Such additives may be employed for the purpose of detecting a portion of a substrate covered by the overcoat composition by scanning sensors used in printing and registration systems and improve the light fastness property of the overcoated prints. Suitable UV absorbing additives for this purpose may have a strong absorption in the UV range of the spectrum, generally comprised of wavelengths below 400 nm, or from about 330 nm to about 400 nm. Of particular interest are the embodiments comprising UV absorbing additives that have a strong absorption in the spectrum range of from about 330 nm to about 400 nm since those additives are efficient absorbers of UV light emitted by the UV black light sources which operate at wavelengths of from about 350 nm and higher.

In the embodiments, overcoat compositions having an amount of UV absorbing additives, such as for example, from the hydroxyphenyl benzotriazole class of compounds, were demonstrated to be detectable with Xerox's Image On Web Array (IOWA) system. In specific embodiments, it was shown that an overcoat composition having about 2 weight percent of 2-(2H-benzotriazol-2-yl)-p-cresol, which is a phenol substituted benzotriazole (also available as TINUVIN P light absorbing material from BASF Other UV absorbing additives include, for example, other hydroxyphenyl substituted benzotriazoles like other TINUVIN materials available from CIBA. Examples include TINUVIN 99 123, 477, 5151 from BASF, 2-(2-hydroxy-3,5-di(1,1-dimethylbenzyl))-2H-benzotriazole commercialized as LOWILITE 234 by the Great Lakes Chemical Corporation. Other benzotriazoles include LOWILITE 26, 27, 28, 29 and 35 all available from the Great Lakes Chemical Company and the like and mixtures thereof. Other suitable materials are hydroxyphenyl substituted triazines like bis-ethylhexyloxyphenol methoxyphenyl triazine) marketed as Tinosorb S by BASF; substituted cinnamates like Octyl methoxycinnamate available under the trade name of Tinosorb OMC; substituted benzophenone materials like for example, 2-hydroxy-4-methoxybenzophenone, commercialized under the name of LOWILITE 20 by the Great Lakes Chemical Corporation in Michigan, USA, currently part of Chemtura Corporation.

In embodiments, the UV absorbing additive is present in the overcoat composition in an amount of from about 0.01 to about 5 weight percent, or from about 0.1 to about 4 weight percent, or from about 0.2 to about 3 weight percent of the total weight of the overcoat composition. For comparison, samples made with clear overcoat compositions without the additives could simply not be detected with UV light, such as black light (UV light @ 365 nm). In contrast, the overcoat samples containing the UV absorbing additives were completely detectable when printed on white paper (XEROX 4200) as well as on various colored paper (XEROX Pastel). The overcoat compositions comprising UV absorbing additives may be particularly advantageous when used with white paper substrates, providing excellent contrast. For comparison, samples made with fluorescent additives showed poor contrast on white paper because their fluorescence is masked or overwhelmed by the blue fluorescence of the white paper. Of the fluorescent additives, only red emitting dyes showed some contrast. Thus, the present embodiments provide an easy and very efficient solution for providing detectability of overcoat compositions.

Optional antioxidants in the overcoat composition may further protect the printed images from oxidation and also may protect the overcoat components from oxidation. Examples of suitable antioxidants include N,N′-hexamethylene bis(3,5-di-tert-butyl-4-hydroxy hydrocinnamamide) (IRGANOX 1098, available from Ciba-Geigy Corporation), 2,2-bis(4-(2-(3,5-di-tert-butyl-4-hydroxyhydrocinnamoyloxy))ethoxyphenyl)propane (TOPANOL-205, available from ICI America Corporation), tris(4-tert-butyl-3-hydroxy-2,6-dimethyl benzyl)isoCyanurate (CYANOX 1790, 41,322-4, LTDP, Aldrich D12, 840-6), 2,2′-ethylidene bis(4,6-di-tert-butylphenyl)fluoro phosphonite (ETHANOX-398, available from Ethyl Corporation), tetrakis(2,4-di-tert-butylphenyl)-4,4′-biphenyl diphosphonite (ALDRICH 46,852-5; hardness value 90), pentaerythritol tetrastearate (TCI America #PO739), tributylammonium hypophosphite (Aldrich 42,009-3), 2,6-di-tert-butyl-4-methoxyphenol (Aldrich 25,106-2), 2,4-di-tert-butyl-6-(4-methoxybenzyl)phenol (Aldrich 23,008-1), 4-bromo-2,6-dimethylphenol (Aldrich 34,951-8), 4-bromo-3,5-didimethylphenol (Aldrich B6,420-2), 4-bromo-2-nitrophenol (Aldrich 30,987-7), 4-(diethyl aminomethyl)-2,5-dimethylphenol (Aldrich 14, 668-4), 3-dimethylaminophenol (Aldrich D14,400-2), 2-amino-4-tert-amylphenol (Aldrich 41, 258-9), 2,6-bis(hydroxymethyl)-p-cresol (Aldrich 22, 752-8), 2,2′-methylenediphenol (Aldrich B4,680-8), 5-(diethylamino)-2-nitrosophenol (Aldrich 26,951-4), 2,6-dichloro-4-fluorophenol (Aldrich 28,435-1), 2,6-dibromo fluoro phenol (Aldrich 26,003-7), α-trifluoro-o-creso-1 (Aldrich 21,979-7), 2-bromo-4-fluorophenol (Aldrich 30,246-5), 4-fluorophenol (Aldrich F1,320-7), 4-chlorophenyl-2-chloro-1,1,2-tri-fluoroethyl sulfone (Aldrich 13,823-1), 3,4-difluoro phenylacetic acid (Aldrich 29,043-2), 3-fluorophenylacetic acid (Aldrich 24,804-5), 3,5-difluoro phenylacetic acid (Aldrich 29,044-0), 2-fluorophenylacetic acid (Aldrich 20,894-9), 2,5-bis(trifluoromethyl)benzoic acid (Aldrich 32,527-9), ethyl-2-(4-(4-(trifluoromethyl)phenoxy)phenoxy)propionate (Aldrich 25,074-0), tetrakis(2,4-di-tert-butyl phenyl)-4,4′-biphenyl diphosphonite (Aldrich 46,852-5), 4-tert-amyl phenol (Aldrich 15,384-2), 3-(2H-benzotriazol-2-yl)-4-hydroxy phenethylalcohol (Aldrich 43,071-4), NAUGARD 76, NAUGARD 512, AND NAUGARD 524 (manufactured by Uniroyal Chemical Company), and the like, as well as mixtures thereof. The antioxidant, when present, may be present in the overcoat composition in any desired or effective amount, such as from about 0.15 percent to about 10 percent by weight of the overcoat composition or from about 0.2 percent to about 3 percent by weight of the overcoat composition.

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### EXAMPLES

This Example shows various overcoat formulations and assesses their performance, in accordance with embodiments disclosed herein.

Overcoat formulations which demonstrated increased gloss and improved scratch and folding properties were prepared with vinyl acetate ethylene binder according to the Formulations shown in Table 3 and 4. Table 3 shows aqueous overcoat formulations with VAE combined with low T_{g} acrylic latexes in a mixed binder Formulation. Table 4 shows aqueous overcoat formulations with only VAE as a singular binder, with other filler additives to increase robustness of the overcoat.

TABLE 3

| | | Formulations | | |
|---|---|---|---|---|
| | | (wet weight %) | | |
| Component | Supplier | 1 | 2 | 3 |
| BriteCoat 2730 (VAE | Celanese Emulsion | 49 | 20 | 20 |
| Emulsion) | Polymers | | | |
| Joncryl 74A (T_{g} = −16° C.) | BASF | | 70 | |
| Joncryl 624 (T_{g} = 30° C.) | | 50 | | 70 |
| Joncryl Wax4 | | | 9 | 9 |
| FS 8050 | Innovative Chemical | 1 | 1 | 1 |
| | Technologies, Inc. | | | |

TABLE 4

| | | Formulations | | | | |
|---|---|---|---|---|---|---|
| | | (wet weight %) | | | | |
| Component | Supplier | 4 | 5 | 6 | 7 | 8 |
| BriteCoat 2730 | Celanese Emulsion | 95 | 97 | 97 | 94 | 94 |
| (VAE Emulsion) | Polymers | | | | | |
| Microspersion 930 | Micro Powers, Inc. | 4 | 2 | | | |
| 23N Additive | Dow Corning | | | 2 | | |
| NanoArc@AL-2255 | Nanophase | | | | 5 | |
| NanoArc@AL-2450 | | | | | | 5 |
| FS 8050 | Innovative Chemical | 1 | | | 1 | 1 |
| | Technologies, Inc. | | | | | |
| OT-75 | CYTEC INDUSTRIES | | 1 | 1 | | |
| | INC. | | | | | |

Solid ink jet prints were generated using a standard solid inkjet printer. A 100% solid magenta image was generated on both 4200 and Xerox 120gsm Digital Color Elite Gloss coated paper. The prints were manually coated with aqueous coating formulations on a Mathis Labcoater using a #2½ Meyer rod with wire diameter of 0.06 mm. The wet coating was then placed in an oven to dry at 80° C. for two minutes. A dry film of about 2 to about 3 microns was obtained on top of the print surfaces.

75 Degrees Gloss:

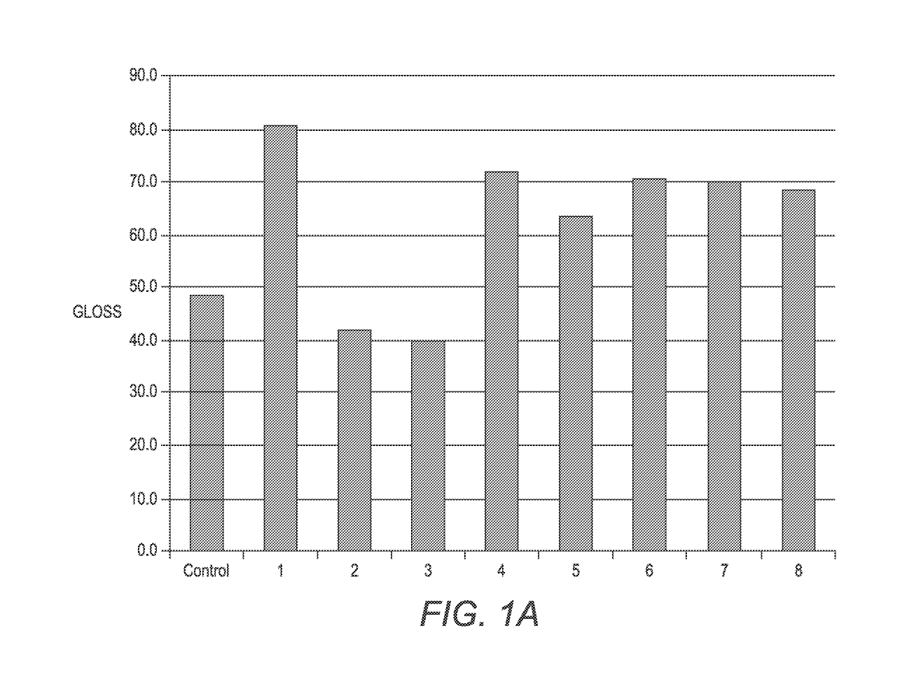

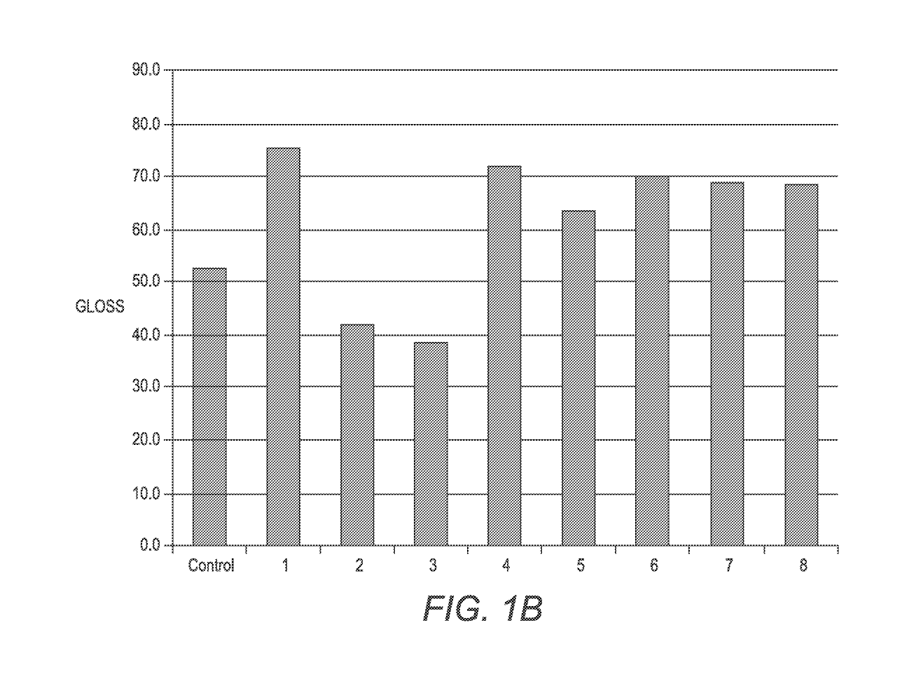

75 degree gloss is measured using a BYK Gardner gloss meter with 75 degree reflection angle. As shown in FIGS. 1A and 1B, the prints gloss was substantially increased after coating with the Formulations shown in Tables 3 and 4. Formulations can exhibit enhanced gloss adjusting the loading of different additives such as micronized wax emulsion or non-agglomerated aluminum oxide nanoparticles.

Fold Test:

Fold tests were conducted on FORMAZ FD38/FD382 Document Folder tester. The test procedure was performed as follows: 1. A sheet of 4200 paper was attached onto the top of the coated sample sheet using a piece of double sided tape; 2. this was placed into the fold tester feeder. 3. the backing sheet was removed and pieces of clear tape were placed along where the ink had been offset on the backing sheet. 4. the ink offset on the backing sheet was examined by comparing it with a sight image rating (SIR) standard or making scan to record the results.

Table 5 shows the fold test results on SIR rating. The lower the rating, the better the performance. For most formulations, the SIR rating is only 1 which means almost no ink offset can be observed on the backing sheet.

TABLE 5

| Coating | SIR Rating | |
|---|---|---|
| Formulation | White Paper | Color Gloss Paper |
| Control | 4.0 | 4.0 |
| 1 | 1.5 | 1.5 |
| 2 | 1.0 | 1.0 |
| 3 | 1.0 | 1.0 |
| 4 | 1.0 | 1.0 |
| 5 | 1.0 | 1.0 |
| 6 | 1.0 | 1.5 |
| 7 | 1.0 | N/A |
| 8 | 1.0 | N/A |

Three Finger Gouge Scratch Test:

A home made three finger gouge scratch tester was used to mimic the human finger scratch on the print surface. Heavy load finger (528 g) and medium load finger (264 g) were lowered on the overcoated print surface and the scratcher was run allowing the fingers to scratch a straight line across the sample at a set speed. Exemplary overcoat Formulation improved scratch resistance on both medium weight (MW=264 g) and heavy weight (HW=528 g) relative to the control. A scratch mark was barely observable on 4200 paper.

RT 4 Wear Test:

A 5 cm diameter circle sample was cut-out using a sample press. A piece of Whatman 54 filter paper was used as receptive sheet. Coating transfer to the filter paper was measured using five-decimal scale. The more mass transfer to the receptive sheet, the worse of the coating wear property. Exemplary results are shown in Table 6 below.

TABLE 6

| Formulation | Mass transfer (mg) |
|---|---|
| control | 2.28 |
| 6 | 1.38 |
| 8 | 0.26 |

Formulation 8 with nanoparticulate aluminum oxide performed particularly well in the wear test.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

It will be appreciated that some of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

All the patents and applications referred to herein are hereby specifically, and totally incorporated herein by reference in their entirety in the instant specification.

What is claimed is:

1. A method comprising:
forming a film over a printed image on a substrate, the film comprising a print overcoat composition comprising:
a binder comprising an aqueous vinylacetate-ethylene copolymer emulsion;
(1) a particulate additive as a dispersion or emulsion, (2) a co-binder, or (3) both; and
a surfactant;
wherein the film provides wear and scratch resistance to the printed image.

2. The method of claim 1, wherein the printed image is ink or toner image.

3. The method of claim 1, wherein the substrate is one selected from the group consisting of uncoated paper, coated paper, synthetic paper and polymer film.

4. The method of claim 1, wherein the co-binder is an acrylic copolymer latex.

5. The method of claim 1, wherein the particulate additive comprises one selected from the group consisting of alumina nanoparticles, a silicone powder, colloidal silica, a micronized wax, and combinations thereof.

6. A print overcoat composition comprising:
a binder comprising aqueous vinylacetate-ethylene copolymer emulsion;
a particulate additive comprising an aqueous dispersion of alumina oxide nanoparticles;
an optional micronized wax emulsion; and
a surfactant.

7. The print overcoat of claim 6, wherein the vinylacetate-ethylene copolymer emulsion is present in an amount from about 5 percent to about 97% by weight of the composition.

8. The print overcoat of claim 6, wherein the vinylacetate-ethylene copolymer is present in the emulsion in an amount from about 15 percent to about 60 percent by weight of the emulsion.

9. The print overcoat of claim 6, wherein the vinylacetate-ethylene copolymer has a vinyl acetate monomer content in a range from about 60 percent to about 95 percent by weight of the copolymer.

10. The print overcoat composition of claim 6, wherein the particulate additive is present in an amount from about 2 percent to about 20 percent by weight of the composition.

11. The print overcoat composition of claim 6, wherein the alumina oxide nanoparticles have a particle size in a range from about 50 nm to about 250 nm.

12. The print overcoat composition of claim 6, wherein the surfactant is present in an amount from about 0.1 percent to about 4 percent by weight of the composition.

13. The print overcoat composition of claim 6, further comprising a leveling agent.

14. The print overcoat composition of claim 6, further comprising a defoamer.

15. A print overcoat composition comprising:
a binder comprising an aqueous vinylacetate-ethylene copolymer;
a co-binder comprising an aqueous polymer latex, wherein the polymer of the latex has a glass transition temperature in a range from −42° C. to about 85° C.; and
a surfactant.

16. The print overcoat composition of claim 15, wherein the aqueous vinylacetate-ethylene copolymer is present in an amount from about 5 percent to about 97 percent by weight of the composition.

17. The print overcoat composition of claim 15, wherein the aqueous polymer latex is an acrylic copolymer latex.

18. The print overcoat composition of claim 15, further comprising a particulate additive selected from the group consisting of a silicone powder, alumina nanoparticles, colloidal silica, a micronized wax powder, dispersion, emulsion, and combinations thereof.

19. The print overcoat composition of claim 15, wherein the polymer of the aqueous polymer latex has a glass transition temperature in a range from about −42° C. to about 85° C.

20. The print overcoat composition of claim 15, wherein the aqueous polymer emulsion is present in an amount from about 2 percent to about 97 percent by weight of the composition.
